(19) United States
(12) Patent Application Publication
(10) Pub. No.: US 2025/0264190 A1
(43) Pub. Date: Aug. 21, 2025

(54) GAS SUPPLY DEVICE

(71) Applicant: TOYOTA JIDOSHA KABUSHIKI KAISHA, Toyota-shi (JP)

(72) Inventors: Keiichi KANEKO, Mishima-shi (JP); Yoshikatsu FUJIMURA, Toyota-shi (JP); Naoki TOMI, Kawasaki-shi (JP); Koji SUGIURA, Toyota-shi (JP); Kei KATO, Nagakute-shi (JP); Tomoki NAKASHIMA, Nagoya-shi (JP); Tetsuya TONOSAKO, Susono-shi (JP)

(73) Assignee: TOYOTA JIDOSHA KABUSHIKI KAISHA, Toyota-shi (JP)

(21) Appl. No.: 19/020,015

(22) Filed: Jan. 14, 2025

(30) Foreign Application Priority Data
Feb. 21, 2024 (JP) 2024-024803

(51) Int. Cl. F17C 7/00; F17C 13/08

(52) U.S. Cl. CPC F17C 7/00; F17C 13/084; F17C 2205/0388; F17C 2221/012; F17C 2223/0123

(57) ABSTRACT

A gas supply device disclosed herein includes a connector attached to and detached from a main stop valve of a gas cartridge, an actuator, and a gas discharger. The actuator moves the connector closer to the main stop valve of the attached gas cartridge. The gas discharger blows gas to the tip of the connector before it is connected to the main stop valve. The gas supply device disclosed in the present specification blows gas to the tip of the connector prior to connecting the connector to the main stop valve to remove dust and the like adhering to the connector. Therefore, it is possible to suppress dust and the like entering the gas supply device.

### CROSS-REFERENCE TO RELATED APPLICATION

This application claims priority to Japanese Patent Application No. 2024-024803 filed on Feb. 21, 2024, incorporated herein by reference in its entirety.

### BACKGROUND

### 1. Technical Field

The technology disclosed in the present specification relates to a gas supply device that enables a gas cartridge to be attached to and detached from the gas supply device, the gas cartridge storing a fuel gas, and the gas supply device supplying the fuel gas in the gas cartridge to a gas utilization device.

### 2. Description of Related Art

There is proposed a technique in which a fuel gas is stored in a gas cartridge and the gas cartridge is mounted to a gas utilization device (Japanese Unexamined Patent Application Publication No. 2023-56952 (JP 2023-56952 A), for example). Examples of the gas utilization device include a fuel cell. JP 2023-56952 A discloses a gas cartridge that is attachable to and detachable from the gas utilization device. A main stop valve of the gas cartridge is connected to a connector on the gas utilization device side through operation to mount the cartridge to the gas utilization device.

### SUMMARY

If dust or the like adheres to the connector when connecting the connector to the main stop valve of the gas cartridge, the dust or the like may be mixed into the gas utilization device together with the fuel gas. The present specification provides a technique of suppressing dust or the like being mixed in when connecting a connector to a main stop valve.

An aspect of the present specification provides a gas supply device including a connector attached to and detached from a main stop valve of a gas cartridge, an actuator, and a gas discharger.

The actuator relatively moves the connector closer to the main stop valve of the gas cartridge mounted to the gas supply device.
The gas discharger blows the gas to a tip of the connector before being connected to the main stop valve.
In the gas supply device disclosed in the present specification, the gas is blown to the tip of the connector before connecting the connector to the main stop valve to remove dust or the like adhering to the connector. Therefore, it is possible to suppress dust or the like being mixed into the gas supply device.

Details of the technique disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a gas supply device 100;

FIG. 2A is a cross-sectional view of a connector-periphery;

FIG. 2B is another cross-sectional view of the connector-periphery;

FIG. 3A is a cross-sectional view of the periphery of a modified connector; and

FIG. 3B is another cross-sectional view of the periphery of the connector of a modification.

### DETAILED DESCRIPTION OF EMBODIMENTS

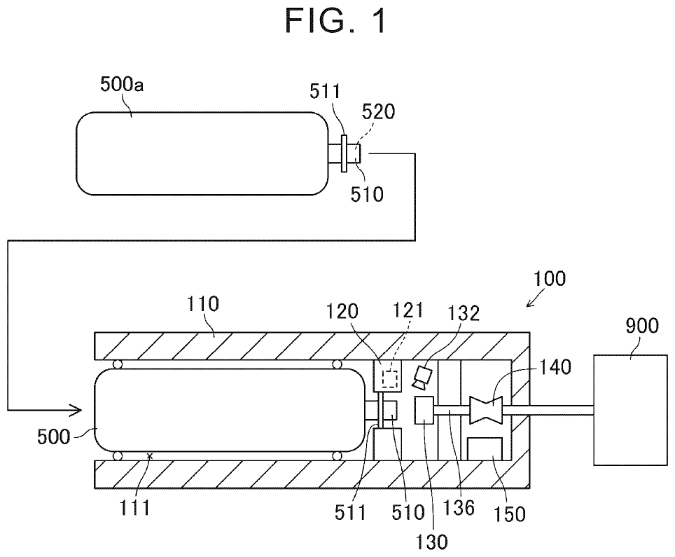

A gas supply device 100 according to an embodiment will be described with reference to the drawings. FIG. 1 is a cross-sectional view of a gas supply device 100. The gas supply device 100 is a device that supplies hydrogen gas (fuel gas) stored in the gas cartridge 500 to the fuel cell 900. The fuel cell 900 corresponds to an example of a gas utilization device.

The gas cartridge 500 is detachable from the gas supply device 100. The reference numeral 500a in FIG. 1 indicates a gas cartridge prior to being installed in the gas supply device 100. The gas cartridge 500a is inserted into the cartridge accommodating space 111 of the housing 110 of the gas supply device 100 by the user. The base 510 of the gas cartridge 500 is provided with a flange 511. The user inserts the gas cartridge 500 into the cartridge accommodating space 111 and rotates the gas cartridge 500. The cartridge accommodating space 111 is provided with a cartridge holder 120. When the gas cartridge 500 rotates in the cartridge accommodating space 111, the flange 511 is locked to the cartridge holder 120. A detailed description of the mechanism for locking the flange 511 (i.e., the gas cartridge 500) is omitted.

A connector 130 is disposed in the cartridge accommodating space 111. Further, the base 510 of the gas cartridge 500 is provided with a main stop valve 520. One end of the gas flow path 136 is connected to the connector 130, and the other end of the gas flow path 136 is connected to the fuel cell 900. An auxiliary valve 140 is attached to the gas flow path 136. When the connector 130 is connected to the main stop valve 520 and the main stop valve 520 and the auxiliary valve 140 are opened, the hydrogen gas in the gas cartridge 500 is supplied to the fuel cell 900 through the gas flow path 136.

When the gas cartridge 500 is secured to the cartridge holder 120, the base 510 faces the connector 130. The cartridge holder 120 is provided with an actuator 121, and when the actuator 121 is operated, the base 510 (the gas cartridge 500) is drawn toward the connector 130. The connector 130 is provided with a push rod, which will be described later, and when the base 510 approaches the connector 130, the push rod pushes open the main stop valve 520. The structure of the connector 130 will be described later.

The actuator 121 includes, for example, a ball screw and a stepping motor. When the stepper motor rotates the ball screw, the jig holding the flange 511 moves toward the connector 130. That is, the gas cartridge 500 approaches the connector 130. Since a known structure may be adopted for the actuator 121, a specific structure of the actuator 121 will not be described. The actuator 121 may move the connector 130 toward the base 510. The actuator 121 may be any mechanism that moves one of the gas cartridge 500 and the connector 130 toward the other. The gas supply device 100 is provided with a controller 150, and the controller 150 controls the actuator 121 and the auxiliary valve 140.

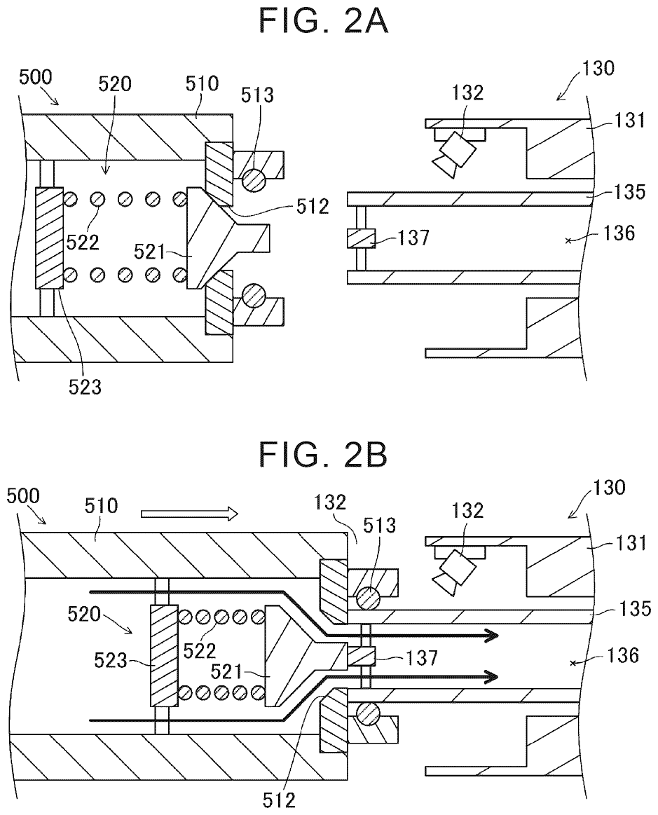

A cross-sectional view of the periphery of the connector 130 is shown in FIGS. 2A and 2B. In FIGS. 2A and 2B, the cartridge holder 120 and the actuator 121 are not shown.

First, the structure of the gas cartridge 500 will be described. The gas cartridge 500 includes a main stop valve 520 in the base 510. The main stop valve 520 blocks an opening 512 provided in the base 510. When the main stop valve 520 is opened, the hydrogen gas (fuel gas) in the gas cartridge 500 is jetted out through the opening 512.

The main stop valve 520 includes a valve body 521 and a spring 522. The valve body 521 blocks the opening 512 from the inside of the gas cartridge 500. The spring 522 presses the valve body 521 against the edge of the opening 512 from the inside of the gas cartridge 500. The rear end of the spring 522 abuts against a stopper 523 provided inside the gas cartridge 500. When the spring 522 presses the valve body 521 against the edge of the opening 512, the opening 512 is closed. When the valve body 521 is pushed into the gas cartridge 500 from the outside of the gas cartridge 500, the main stop valve 520 opens and the hydrogen gas is ejected.

The connector 130 of the gas supply device 100 includes a push rod 135 and a blower 132 secured to the connector base 131. The inside of the push rod 135 serves as a gas flow path 136. Further, a push piece 137 is provided at the tip of the push rod 135. The push piece 137 pushes the valve body 521. The push piece 137 is fixed to the tip of the push rod 135, but does not block the gas flow path 136 of the push rod 135, when the main stop valve 520 is opened hydrogen gas passes through the side of the push piece 137 to the gas flow path 136.

The blower 132 discharges air. The discharge port of the blower 132 faces the distal end of the push rod 135. FIG. 2A shows the gas cartridge 500 prior to the base 510 contacting the connector 130. When the gas cartridge 500 is fixed to the cartridge holder 120 and the connector 130 faces the base 510, the controller 150 activates the blower 132. The blower 132 vigorously blows air to the tip of the connector 130 (the tip of the push rod 135). At this time, the main stop valve 520 is still closed.

The controller 150 then stops the blower 132, actuates the actuator 121, and brings the base 510 closer to the connector 130. As described above, when the main stop valve 520 of the base 510 approaches the connector 130, the push piece 137 at the tip of the push rod 135 pushes the valve body 521 into the gas cartridge 500. The valve body 521 is separated from the opening 512, and the main stop valve 520 is opened. When the main stop valve 520 is opened, the hydrogen gas flows through the side of the push piece 137 to the gas flow path 136. In FIG. 2B, the main stop valve 520 is opened, and the hydrogen gas inside the gas cartridge 500 flows into the gas flow path 136. The thick arrow line in FIG. 2B indicates the flow of hydrogen-gas. As described above, the gas flow path 136 is connected to the fuel cell 900, and when the auxiliary valve 140 of FIG. 1 is opened, the hydrogen gas is supplied to the fuel cell 900.

The gap between the outer periphery of the push rod 135 approaching the main stop valve 520 and the base 510 is sealed by a gasket 513.

In the gas supply device 100 of the embodiment, before the push rod 135 opens the main stop valve 520, the blower 132 blows air to the tip of the connector 130 (the outer surface of the tip of the push rod 135). The dust or the like adhering to the outer surface of the distal end of the push rod 135 is removed. When the hydrogen gas is supplied to the fuel cell 900 through the gas flow path 136, dust and the like are prevented from entering. The blower 132 is an example of a gas discharger that discharges air to the tip of the push rod 135.

### Modification

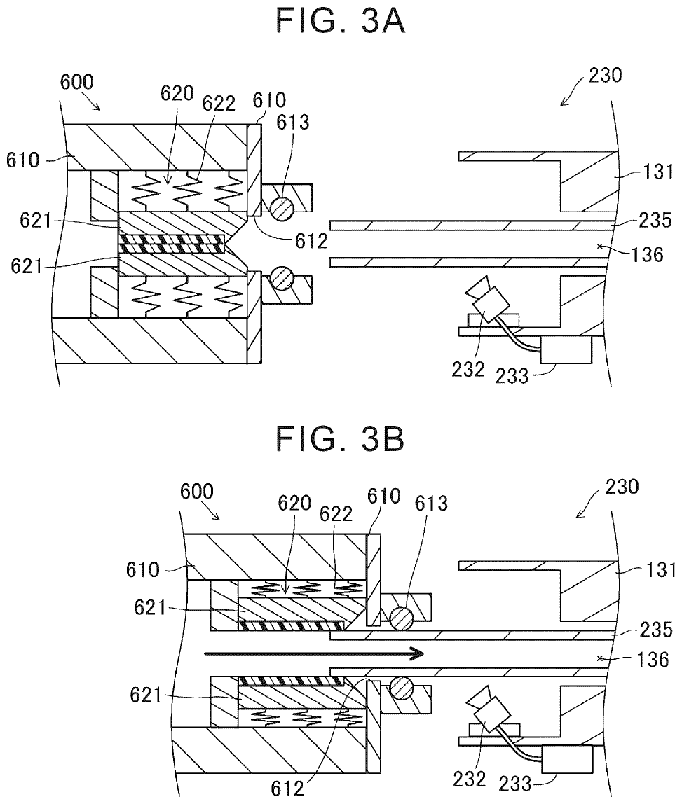

A modification of the main stop valve and the connector will be described. FIGS. 3A and 3B show cross-sectional views of the periphery of a modified main stop valve 620 and a modified connector 230. The gas supply device of the modified example includes a gas discharger 232. The gas discharger 232 sprays the nitrogen gas in the nitrogen tank 233 onto the tip of the connector 230 (the tip of the push rod 235). Nitrogen gas is a typical inert gas that does not significantly affect the operation of the fuel cell 900 when mixed into 25 the fuel cell 900.

The main stop valve 620 has two valve bodies 621. The two valve bodies 621 are located inside the opening 612 of the gas cartridge 600. The two valve bodies 621 are pressed against each other by a spring 622 and block the opening 612 of the base 610 (FIG. 3A).

FIG. 3A shows the gas cartridge 600 prior to the base 610 contacting the connector 230. In FIGS. 3A and 3B, the flanges of the base 610 and the cartridge holder and the actuator of the gas supply device are illustrated. When the gas cartridge 600 is fixed to the cartridge holder and the connector 230 faces the base 610, the controller of the gas supply device activates the gas discharger 232. The gas discharger 232 blows nitrogen gas to the tip of the connector 230 (the tip of the push rod 235). At this time, the main stop valve 620 is still closed.

The controller deactivates the gas discharger 232 and actuates the actuator to bring the base 610 closer to the connector 230. As the distal end of the base 610 approaches the connector 230, the distal end of the push rod 235 pushes open the two valve bodies 621 of the main stop valve 620, and the main stop valve 620 opens (FIG. 3B). The hydrogen gas in the gas cartridge 600 passes through the opening 612 and flows into the gas flow path 136 inside the push rod 235. The gas flow path 136 is connected to the fuel cell 900, and when the auxiliary valve 140 of FIG. 1 is opened, hydrogen gas is supplied to the fuel cell 900. The thick arrow line in FIG. 3B represents the flow of hydrogen-gas. The gap between the outer periphery of the push rod 235 approaching the main stop valve 620 and the base 610 is sealed by a gasket 613.

The gas supply device having the connector 230 of the modified example also has the same advantages as the gas supply device 100 of the first embodiment.

Some features of the gas supply device described in the examples are listed below. The gas supply device includes a gas discharger that blows gas to a tip of the connector (a tip of the push rod). The gas supply device of the first embodiment includes a blower 132 that blows air to the tip of the connector. The blower 132 is an example of a gas discharger. The controller of the gas supply device operates the blower 132 prior to connecting the connector to the main stop valve of the gas cartridge. The gas discharged by the blower 132 removes dust and the like from the connector tip (push rod tip). Dust or the like is prevented from being mixed into the fuel cell 900. The controller stops the blower and controls the actuator such that the connector 130 (230) moves further towards the main stop valve 520 (620). When the connector 130 (230) is connected to the main stop valve 520 (620) and the main stop valve 520 (620) is opened, hydrogen gas is supplied to the fuel cell 900 through the connector.

The main stop valve includes a valve body that closes an opening of the gas cartridge from the inside of the gas cartridge, and a spring that presses the valve body against the opening. The connector includes a push rod that pushes open the valve body from the outside of the gas cartridge. When the connector abuts against the main stop valve and the connector further moves toward the main stop valve, the tip of the push rod pushes open the valve body, and the main stop valve opens. The gas discharger sprays gas on the outside of the push rod. The gas may be air or an inert gas such as nitrogen.

A gasket 513 (613) is disposed around the opening of the base. Just before the push rod pushes open the main stop valve, the push rod is inserted into the gasket. The gasket seals between the outer periphery of the push rod and the base.

The fuel cell 900 is an example of a gas utilization device. The gas-utilizing device may be a device other than a fuel cell. The gas supply device of the embodiment may be incorporated in a gas utilization device.

Although specific examples of the disclosure have been described in detail above, the examples are merely examples and do not limit the scope of claims. The technique described in the claims includes various modifications and variations of the specific examples exemplified above. The technical elements described in the present specification or in the drawings exhibit technical usefulness alone or in various combinations, and are not limited to the combinations described in the claims at the time of filing the application. In addition, the technique exemplified in the present specification or drawings can achieve a plurality of purposes at the same time, and achieving one of the purposes itself has technical usefulness.

What is claimed is:

1. A gas supply device that enables a gas cartridge to be mounted to the gas supply device, the gas cartridge storing a fuel gas and including a main stop valve that seals the fuel gas, and the gas supply device supplying the fuel gas in the gas cartridge to a gas utilization device and comprising:
a connector attached to and detached from the main stop valve;
an actuator that relatively moves the connector closer to the main stop valve of the gas cartridge mounted to the gas supply device; and
a gas discharger that blows the gas to a tip of the connector before being connected to the main stop valve.
